(19) United States
(12) Patent Application Publication
(10) Pub. No.: US 2012/0318965 A1
(43) Pub. Date: Dec. 20, 2012

(54) OPTICAL TRANSMISSION SYSTEM AND OPTICAL TRANSMISSION METHOD

(75) Inventor: Akihiro TOSAKI, Tokyo (JP)

(73) Assignee: NEC CORPORATION, Tokyo (JP)

(21) Appl. No.: 13/523,988

(22) Filed: Jun. 15, 2012

(30) Foreign Application Priority Data
Jun. 16, 2011 (JP) 2011-134169

(51) Int. Cl. G01J 1/04

(52) U.S. Cl. 250/227.11

(57) ABSTRACT

A transmitter including a light source and a dither modulator, which applies dither modulation to light output from the light source, an optical fiber, which transmits signal light output from the transmitter, an optical branching device, which branches a part of the signal light transmitted by the optical fiber as monitoring light, a frequency detector, which detects a frequency of the monitoring light, and a detector, which detects whether the frequency of the monitoring light and a modulation frequency set in the dither modulator conform to each other are provided. The frequency detector is provided with, for example, a photoelectric conversion element, which converts the monitoring light to an electric signal, a Fourier transformer, which applies Fourier transform to the electric signal, and a frequency variable filter, which extracts the frequency of the signal to which the Fourier transform is applied.

### INCORPORATION BY REFERENCE

This application is based upon and claims the benefit of priority from Japanese patent application No. 2011-134169, filed on Jun. 16, 2011, the disclosure of which is incorporated herein in its entirety by reference.

### TECHNICAL FIELD

The present invention relates to an optical transmission system and an optical transmission method and especially relates to the optical transmission system and the optical transmission method including a detecting function for preventing optical fiber improper connection by dither modulation.

### BACKGROUND ART

In a conventional wavelength division multiplexing (hereinafter, referred to as WDM) transmission system, a network management system (hereinafter, referred to as NMS) manages an entire transmission channel network (including optical path information between devices). The NMS is indispensable in improving reliability and convenience of a WDM transmission network. Specifically, the NMS is provided with a database of connection information (data about wavelength and destination node) about optical path setting, and the NMS is capable of remotely setting/changing an optical path of each device in an integrated manner. Provisioning of the optical path information is performed to a line card having each function in the device.

The patent literature 1 discloses to apply a dither signal to an optical fiber by an oscillating piston to detect the operated optical fiber as technology related to the invention of the present application.

### CITATION LIST

### Patent Literature

{PTL 1} JP-A-2010-224541 (paragraphs 0025, 0026 and the like).

### SUMMARY OF INVENTION

### Technical Problem

There is a following disadvantage in the conventional NMS and OCM. Herein, the OCM is an abbreviation of an optical channel monitor.

A first disadvantage is that, although the NMS has a function to logically set a network path of the transmission channel network, the NMS cannot physically detect whether the optical fiber is normally connected.

A second disadvantage is that, although the OCM has a function to detect light power and the number of wavelength of a light signal in a certain node, the OCM cannot detect a transmitted wavelength.

Recently, a larger capacity and higher speed of the WDM system are realized and complicated optical fiber wiring is inevitable even between the devices. Therefore, it is important to avoid the improper connection of the optical fiber.

An exemplary object of the present invention is to realize a preventing function of the improper connection of the optical fiber, which cannot be realized by a current optical transmission device configuration in the configuration used in the WDM system. Further, an exemplary object of the present invention is to realize detecting of the transmitted wavelength in the OCM.

An optical transmission system according to a first exemplary aspect of the present invention includes:

a transmitter including a light source and a dither modulator, the dither modulator applying dither modulation to light output from the light source;

an optical fiber which transmits signal light output from the transmitter;

an optical branching device which branches a part of the signal light transmitted by the optical fiber as monitoring light;

a frequency detector which detects a frequency of the monitoring light; and

a detector which detects whether the frequency of the monitoring light and a modulation frequency set in the dither modulator conform to each other.

An optical transmission method according to a second exemplary aspect of the present invention includes:

transmitting signal light through an optical fiber, the signal light being obtained by applying dither modulation to light output from a light source by a dither modulator;

branching a part of the signal light transmitted by the optical fiber as monitoring light and detecting a frequency of the monitoring light; and

detecting whether the frequency of the monitoring light and a modulation frequency set in the dither modulator conform to each other.

Further, an optical transmission system according to a third exemplary aspect of the present invention includes:

an optical branching device which branches a part of transmitted dither modulation signal light as monitoring light; and an optical channel monitor to which the monitoring light is input, wherein

the optical channel monitor includes a photoelectric conversion element which converts the monitoring light to an electric signal, a Fourier transformer which applies Fourier transform to the electric signal, a frequency variable filter which extracts a frequency of the signal to which the Fourier transform is applied, and a calculating unit which calculates a peak of a frequency spectrum output from the frequency variable filter.

Further, an optical transmission method according to a fourth exemplary aspect of the present invention includes:

branching a part of transmitted dither modulation signal light as monitoring light;

converting the monitoring light to an electric signal by a photoelectric conversion element;

applying Fourier transform to the electric signal;

extracting a frequency of the signal to which the Fourier transform is applied; and

obtaining a peak of a frequency spectrum.

### Advantageous Effect of Invention

According to the present invention, since it is detected whether the frequency of the monitoring light and the modulation frequency set in the dither modulator conform to each other, it is possible to detect the improper connection of the optical fiber. Also, the OCM may detect the transmitted wavelength.

### BRIEF DESCRIPTION OF DRAWINGS

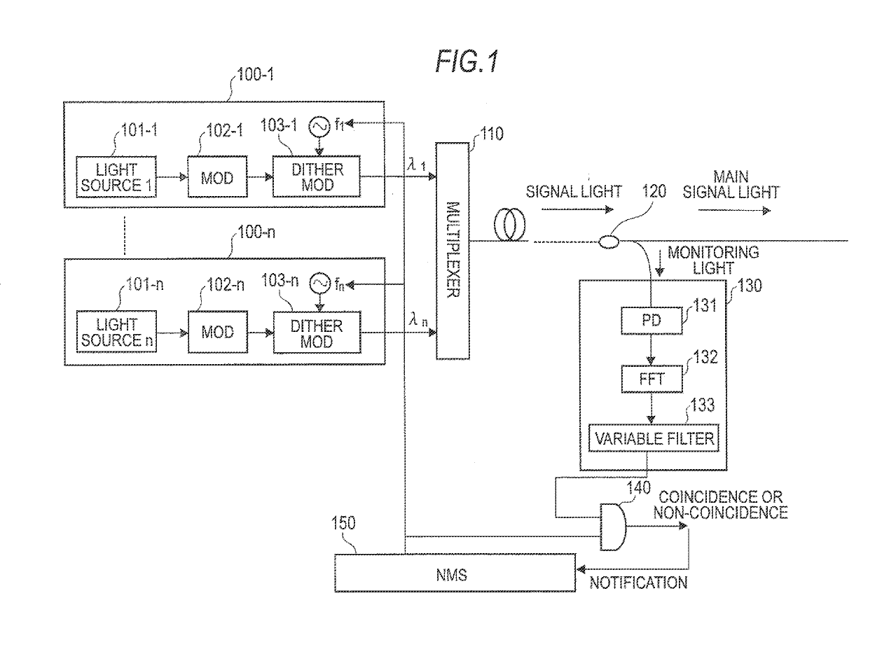

{FIG. 1} A view illustrates a basic configuration of an example of a wavelength division multiplexing (hereinafter, referred to as WDM) transmission system according to the present invention.

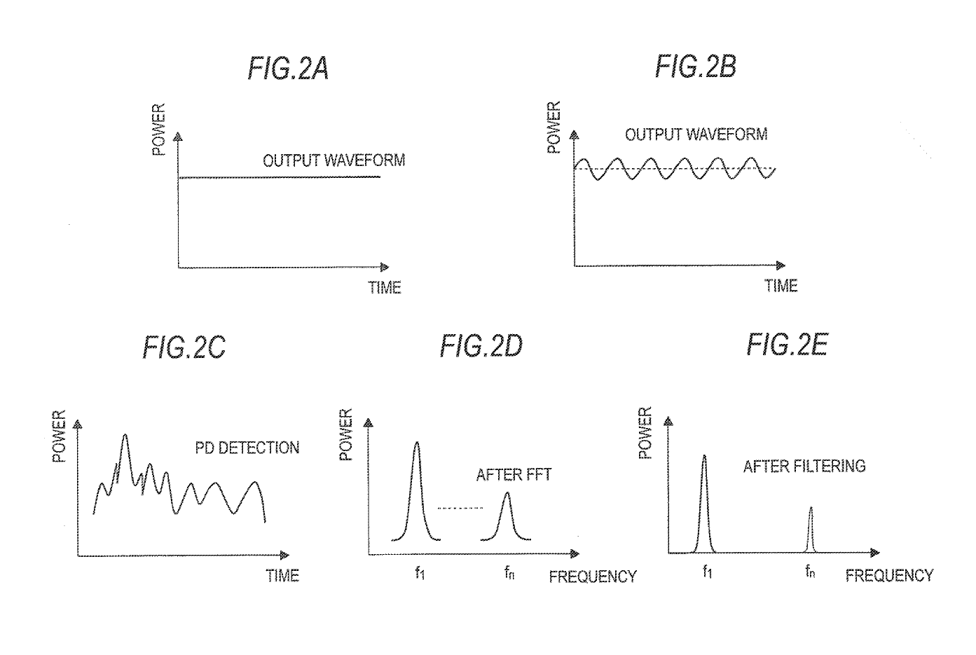

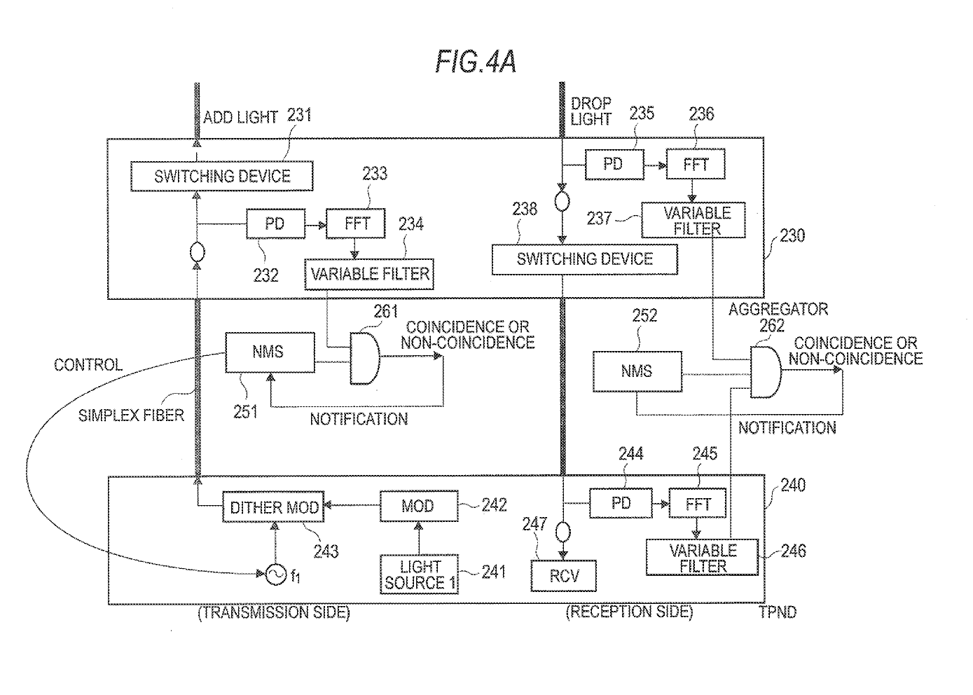

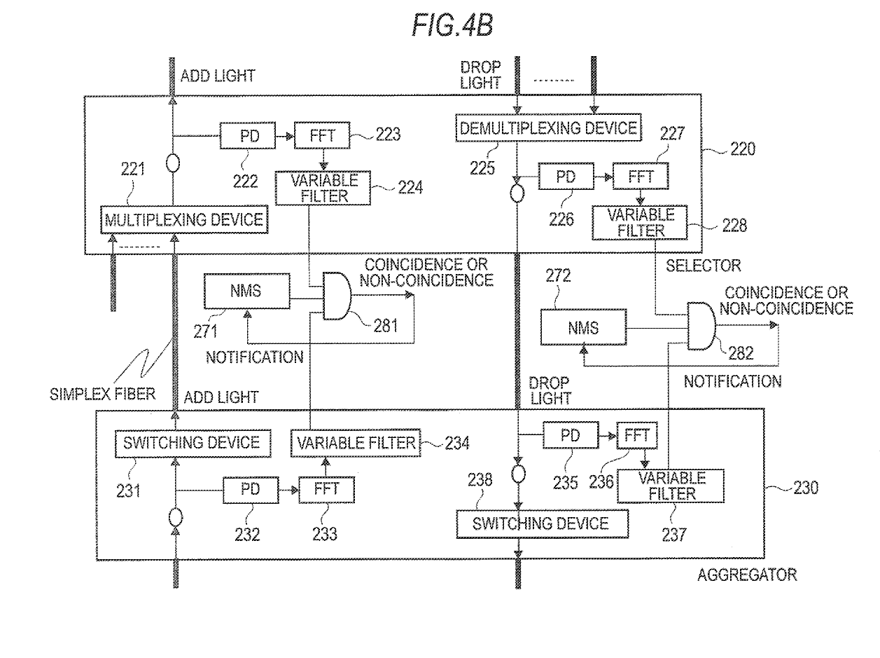

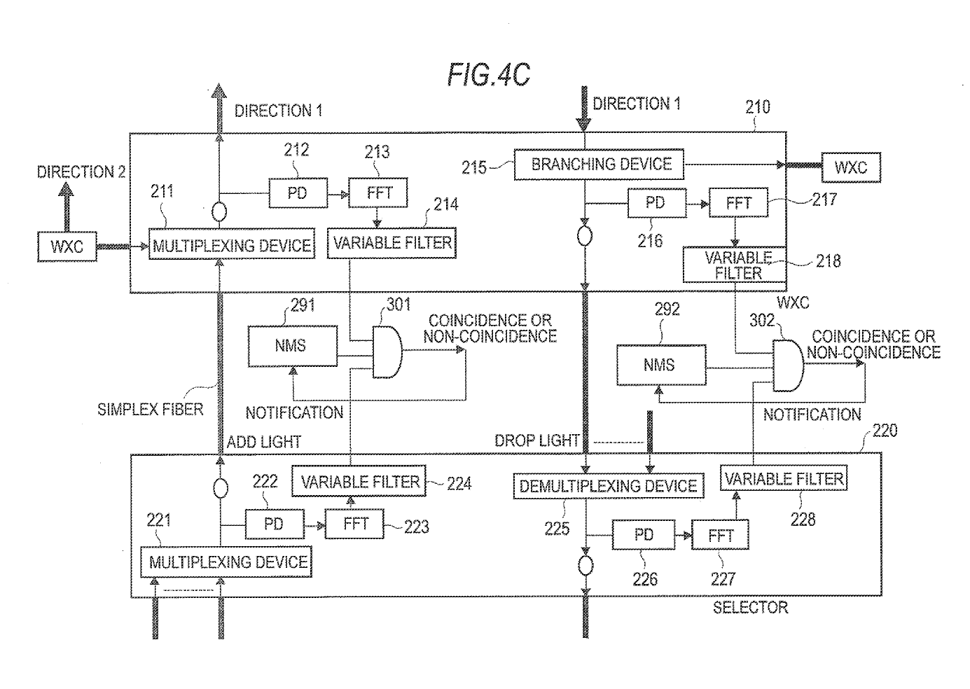

{FIGS. 2A to 2E} Views illustrate signal waveforms of units illustrated in FIGS. 1 and 4A to 4C.

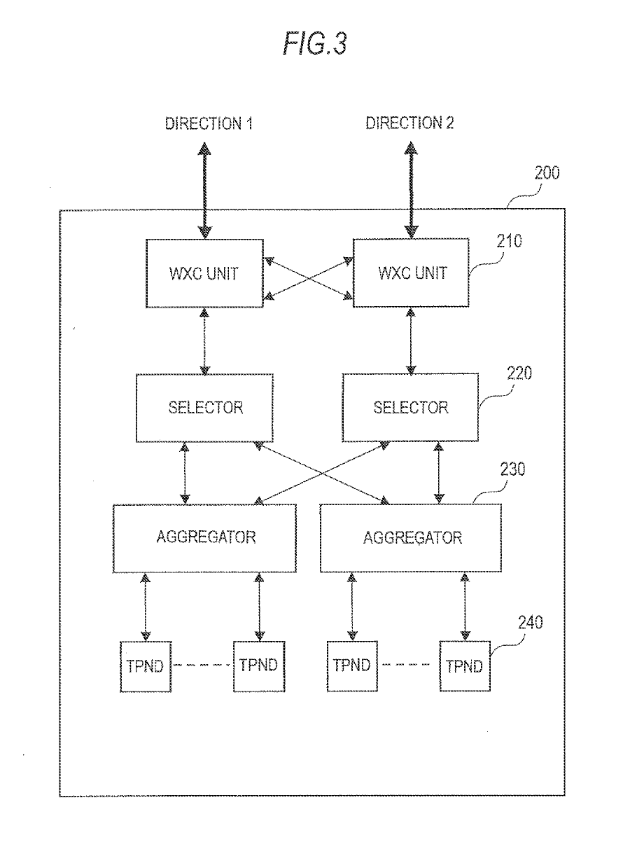

{FIG. 3} A block diagram illustrates a configuration of a ROADM.

{FIG. 4A} A block diagram illustrates each configuration unit of the ROADM in FIG. 3 and illustrates a transponder, an aggregator, and connection therebetween.

{FIG. 4B} A block diagram illustrates each configuration unit of the ROADM in FIG. 3 and illustrates the aggregator, a selector, and the connection therebetween.

{FIG. 4C} A block diagram illustrates each configuration unit of the ROADM in FIG. 3 and illustrates the selector, a WXC unit, and the connection therebetween.

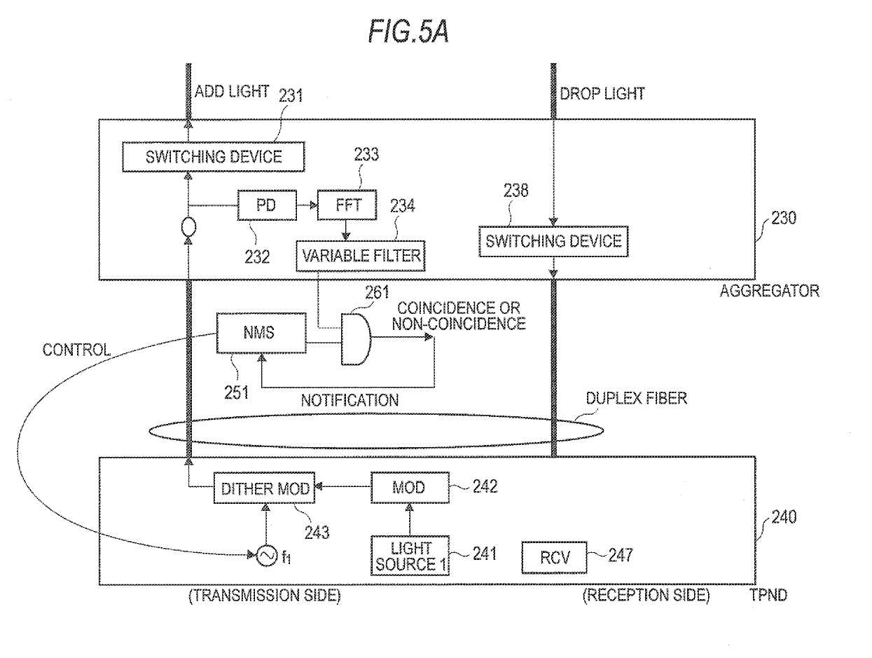

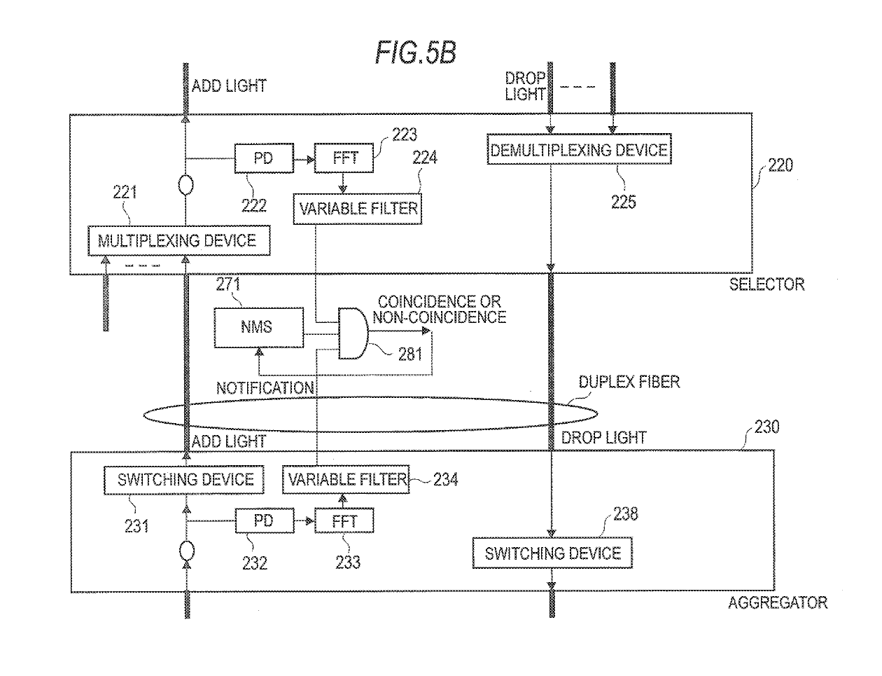

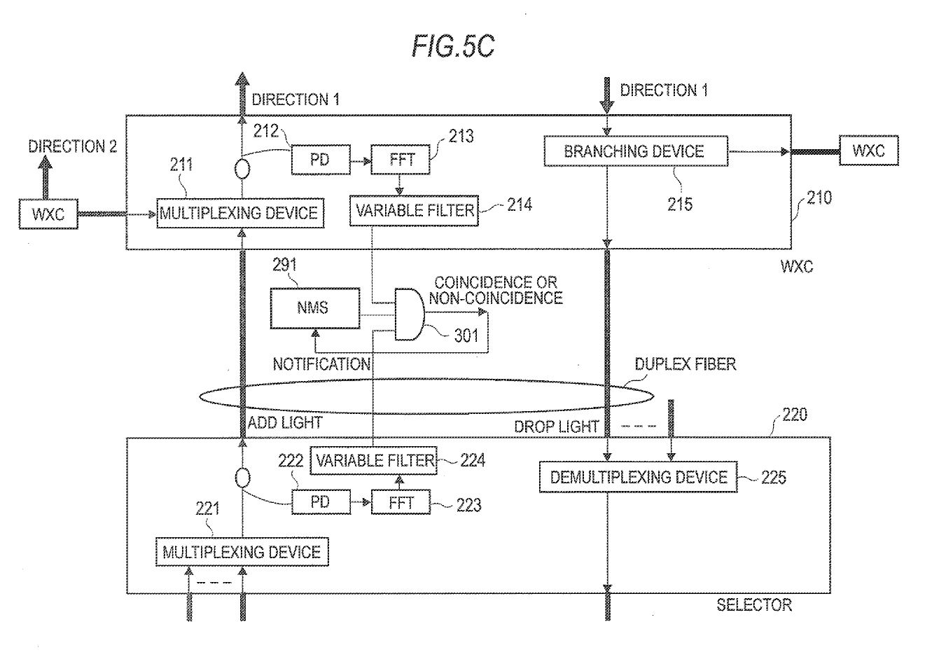

{FIG. 5A} A block diagram illustrates each configuration unit of another example of the ROADM in FIG. 3 and illustrates the transponder, the aggregator, and the connection therebetween.

{FIG. 5B} A block diagram illustrates each configuration unit of another example of the ROADM in FIG. 3 and illustrates the aggregator, the selector, and the connection therebetween.

{FIG. 5C} A block diagram illustrates each configuration unit of another example of the ROADM in FIG. 3 and illustrates the selector, the WXC unit, and the connection therebetween.

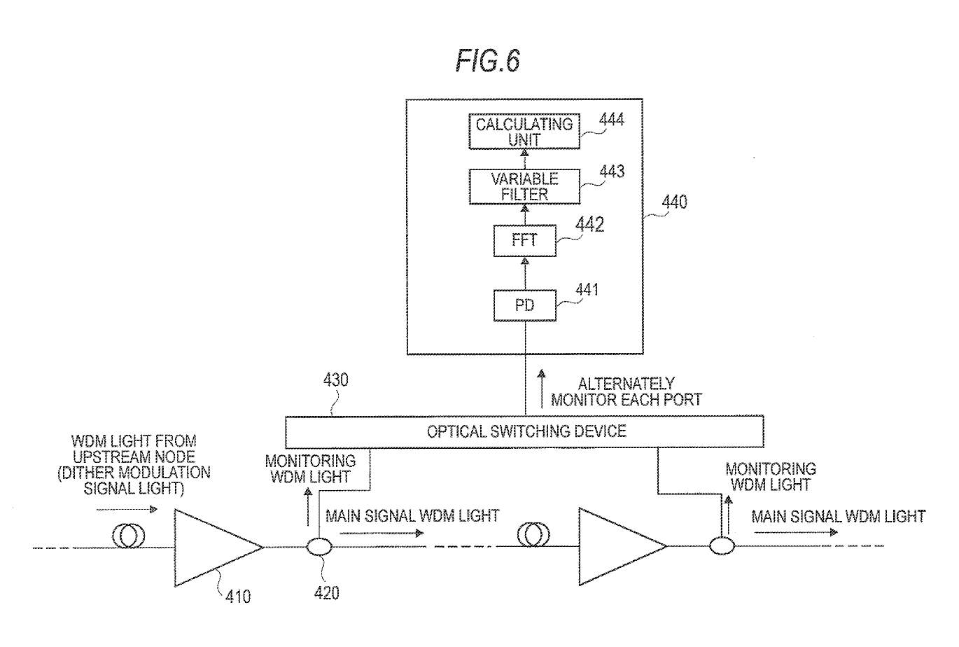

{FIG. 6} A block diagram illustrates a configuration used in a WDM system including an optical channel monitor.

### DESCRIPTION OF EMBODIMENTS

Hereinafter, exemplary embodiments according to the present invention will be described in detail with reference to the drawings.

### First Exemplary Embodiment

FIG. 1 is a view illustrating a basic configuration of an example of an exemplary embodiment of a wavelength division multiplexing (WDM) transmission system according to the present invention.

Transponders (transmitters) 100-1 to 100-n include light sources (LDs) 101-1 to 101-n, modulators (MODs) 102-1 to 102-n, which perform modulation such as intensity modulation/phase modulation for signal transmission, and dither modulators (dither MODs) 103-1 to 103-n, which perform minute modulation (dither modulation), respectively, on a transmission side thereof. By presence of the light sources (LDs) 101-1 to 101-n, the modulators (MODs) 102-1 to 102-n, and the dither modulators (dither MODs) 103-1 to 103-n in this manner, the minute modulation (dither modulation) is intentionally applied to a light signal output from each transponder and labeling of signal light is performed. An NMS 150 manages a modulation frequency assigned to each wavelength. The modulators (MODs) 102-1 to 102-n applies the intensity modulation/phase modulation of a signal, which should be transmitted, to CW light output from the light sources (LDs) 101-1 to 101-n. A multiplexer 110 multiplexes the light signals output from the transponders: any means may be used for multiplexing the light signals from a plurality of transponders.

Next, for example, an optical branching device 120 branches the signal light from the multiplexer 110 into the main signal light and monitoring light and the monitoring light is input to a frequency detector 130. The frequency detector 130 is provided with a PD 131, which acts as a photoelectric conversion element, a fast Fourier transform (FFT) unit 132 (which acts as a Fourier transformer), and a variable filter (frequency variable filter) 133. It is possible to judge whether optical fiber connection is proper depending on whether each frequency extracted by the variable filter 133 and the modulation frequency set in each transponder by the NMS 150 conform to each other. Each of the transponders (transmitters) 100-1 to 100-n and the multiplexer 110 are connected to each other by means of an optical fiber and it is possible to judge whether the optical fiber connection is proper. It is judged whether the optical fiber connection is proper by inputting a signal of each frequency extracted by the variable filter 133 and a signal of the modulation frequency set by the NMS 150 to a detection circuit 140 and detecting whether they conform to each other (detecting coincidence or non-coincidence). Although the detection circuit 140 is herein composed of an AND circuit, a circuit configuration thereof is not especially limited. In this manner, this exemplary embodiment provides a detecting function of optical fiber improper connection by applying the dither modulation to the light signal, obtaining the frequency from the branched monitoring light, and comparing the same with the modulation frequency set by the NMS.

With reference to FIG. 3, a reconfigurable optical add/drop multiplexer (ROADM) configuration, which realizes colorless, contentionless, and directionless at the same time, is illustrated as a configuration example in which the configuration of this exemplary embodiment is used.

Each function to realize a configuration of the configuration example is hereinafter described.

The term “colorless” is intended to mean that the transponder may be connected to a main signal line by all channels (wavelengths) used in the system regardless of a port of the ROADM to which the transponder is connected. At that time, it may be supposed that another transponder used at the same time and a main signal do not occupy the channel in question.

The term “contentionless” is intended to mean that the ROADM having a directionless function may be connected to the transponders even when connection in a plurality of connected directions is performed by the same channel (wavelength). For example, in a case of the ROADM provided with four directions and four transponders, when the transponders are connected to different directions, it is possible to connect the four transponders by the same channel (wavelength) at the same time.

The term “directionless” is intended to mean that the transponder may be connected to the main signal of all the directions connected to the ROADM regardless of the port of the ROADM to which the transponder is connected. At that time, it is only necessary that at least a connection channel of the direction in question is an unused channel.

A function of each unit, which realizes the ROADM configuration illustrated in FIG. 3, is hereinafter described. A ROADM 200 is provided with a wavelength cross connect (hereinafter, referred to as WXC) unit 210, a selector 220, an aggregator 230, and a transponder (TPND) 240.

The WXC unit 210 has a function to divide the signal from a specific direction to transfer the same to a designated direction and to output the same to a Drop terminal so as to be received by a local TPND.

The selector 220 has a function to perform direction switch control in units of wavelength of an optical Drop signal of which direction is selected and output the same to the Drop terminal so as to be received by the local TPND and to multiplex optical Add signals of which directions are selected to output to an Add terminal.

The aggregator 230 has a function to output the light signal from an optional input port to the Drop terminal so as to be received by the local TPND for an optional single output port or a plurality (or all) of the output ports at the same time, and to output the light signal from the optional input port to the Add terminal for the optional single output port or a plurality (or all) of the output ports at the same time.

With reference to FIGS. 4A, 4B, and 4C, a detailed configuration of the ROADM illustrated in FIG. 3 is illustrated.

In the drawings, each unit, which realizes the ROADM configuration, is provided with a detecting function of frequency modulation for detecting the optical fiber improper connection not only for the connection to the transponder but also for the connection between each unit. The transponder (TPND) 240 and the aggregator 230, the aggregator 230 and the selector 220, and the selector 220 and the wavelength cross connect unit 210 are connected to each other by means of the optical fiber, respectively. In FIGS. 4A to 4C, the optical fiber improper connection is detected between the transponder (TPND) 240 and the aggregator 230, between the aggregator 230 and the selector 220, and between the selector 220 and the wavelength cross connect unit 210. However, it is also possible to detect the optical fiber improper connection in any one or two or more of sections between the transponder (TPND) 240 and the aggregator 230, between the aggregator 230 and the selector 220, and between the selector 220 and the wavelength cross connect unit 210.

FIG. 4A is a block diagram illustrating the transponder, the aggregator, and connection therebetween. FIG. 4B is a block diagram illustrating the aggregator, the selector, and the connection therebetween. FIG. 4C is a block diagram illustrating the selector, the WXC unit, and the connection therebetween.

In FIGS. 4A to 4C, it is configured to use a simplex fiber as the optical fiber connection, so that each unit is provided with the detecting function of the frequency modulation on each of an Add side and a Drop side thereof.

When a duplex fiber is used as the optical fiber connection, connection is made by a pair of transmission and reception, so that it is only necessary that the detecting function of the frequency modulation is provided only on the Add side or the Drop side.

The signal on the Drop side is the signal transmitted between nodes and is affected by noise during propagation, so that it is possible to prevent the optical fiber improper connection by providing the detecting function of the frequency modulation on the Add side to monitor together with the NMS. FIGS. 5A to 5C illustrate configurations. In FIGS. 5A to 5C, the same reference signs are assigned to the same components as those in FIGS. 4A to 4C and the description thereof is omitted.

Next, operation in FIGS. 1 and 4A to 4C is described by using a signal waveform illustrated in FIG. 2.

In FIG. 2, an output of a light source 241 mounted in the transponder (TPND) 240 is output as the CW light with constant intensity as illustrated in FIG. 2A. A modulator (MOD) 242 applies the modulation such as the intensity modulation/phase modulation for the signal transmission to the CW light. A dither MOD 243 intentionally applies the minute modulation (dither modulation) for labeling to the signal obtained by applying the modulation to the CW light according to the modulation frequency specified by the NMS. The signal waveform obtained after the dither modulation is illustrated in FIG. 2B as an example. At that time, database and the like of the modulation frequency is made in advance in an NMS 251 in consideration of the wavelength of the transponder and the port to which the transponder is connected.

The signal light from the dither MOD 243 is branched into the main signal light and the monitoring light by the optical branching device in the aggregator 230. The main signal light is output through a switching device 231. The monitoring light is first received by a photo diode (PD) 232, which acts as the photoelectric conversion element. A PD received waveform is illustrated in FIG. 2C. Since frequency components are mixed in the signal waveform, it is not possible to determine the transmitted wavelength. If the frequency component may be extracted, the transmitted wavelength may be determined, so that the fast Fourier transform (FFT) is applied to the received signal by the FFT 233 to convert a certain optional time waveform to a frequency waveform. At that time, the waveform after the FFT is illustrated in FIG. 2D and the waveform after filtering by a variable filter (frequency variable filter) 234 is illustrated in FIG. 2E. In a case illustrated in FIG. 1, when two waves of λ1 (modulation frequency f1) and λn (modulation frequency fn) are transmitted to the transponder, for example, peaks appear at f1 and fn after the FFT and it is understood that signals λ1 and λ2 are transmitted. It is possible to judge whether the optical fiber connection is proper depending on whether each frequency extracted by the variable filter 234 and the modulation frequency set in the transponder by the NMS 251 conform to each other. It is judged whether the optical fiber connection is proper by inputting the signal of each frequency extracted by the variable filter 234 and the signal of the modulation frequency set by the NMS 251 to a detection circuit 261 such as the AND circuit and detecting whether they conform to each other (detecting coincidence or non-coincidence).

The configurations of the above-described transponder (TPND) 240 and AGGREGATOR 230 are the configurations related to the transmission side. A receiver (RCV) 247, which receives the main signal light, a PD 244 to which the monitoring light is input, an FFT 245, which performs the fast Fourier transform, and a variable filter 246 are provided on the transponder (TPND) 240 on the reception side. A switching device 238, which outputs the main signal light, a PD 235 to which the monitoring light is input, an FFT 236, which performs the fast Fourier transform, and a variable filter 237 are provided on the aggregator 230 on the reception side. It is possible to judge whether the optical fiber connection is proper depending on whether each frequency extracted by each of the variable filters 237 and 246 and the modulation frequency set by an NMS 252 conform to each other. It is judged whether the optical fiber connection is proper by inputting the signal of each frequency extracted by each of the variable filters 237 and 246 and the signal of the modulation frequency set by the NMS 252 to a detection circuit 262 such as the AND circuit and detecting whether they conform to each other (detecting coincidence or non-coincidence). In FIG. 5A, the aggregator 230 doesn't include the PD 235, the FFT 236, and the variable filter 237, and the transponder (TPND) 240 doesn't include the PD 244, the FFT 245, and the variable filter 246. Further, in FIG. 5A, the NMS 252 and the detection circuit 262 aren't arranged between the aggregator 230 and the transponder (TPND) 240.

The configuration and the operation for judging whether the optical fiber connection is proper between the transponder (TPND) 240 and the aggregator 230 in FIG. 4A are described above. Such operation is realized by the similar configuration also between the aggregator 230 and the selector 220 illustrated in FIG. 4B and between the selector 220 and the WXC unit 210 illustrated in FIG. 4C.

The selector 220 illustrated in FIG. 4B includes a multiplexing device 221, a PD 222, an FFT 223, and a variable filter 224 on the transmission side and includes a demultiplexing device 225, a PD 226, an FFT 227, and a variable filter 228 on the reception side. An NMS 271 and a detection circuit 281 are arranged between the aggregator 230 and the selector 220 on the transmission side. An NMS 272 and a detection circuit 282 are arranged between the aggregator 230 and the selector 220 on the reception side. In FIG. 5B, the selector 220 doesn't include the PD 226, the FFT 227, and the variable filter 228, and the aggregator 230 doesn't include the PD 235, the FFT 236, and the variable filter 237. Further, in FIG. 5B, the NMS 272 and the detection circuit 282 are arranged between the selector 220 and the aggregator 230.

The WXC unit 210 illustrated in FIG. 4C includes a multiplexing device 211, a PD 212, an FFT 213, and a variable filter 214 on the transmission side and includes a demultiplexing device 215, a PD 216, an FFT 217, and a variable filter 218 on the reception side. An NMS 291 and a detection circuit 301 are arranged between the WXC unit 210 and the selector 220 on the transmission side. An NMS 292 and a detection circuit 302 are arranged between the WXC unit 210 and the selector 220 on the reception side. In FIG. 5C, the WXC unit 210 doesn't include the PD 216, the FFT 217, and the variable filter 218, and the selector 220 doesn't include the PD 226, the FFT 227, and the variable filter 228. Further, in FIG. 5C, the NMS 292 and the detection circuit 302 are arranged between the WXC unit 210 and the selector 220.

### Second Exemplary Embodiment

A second exemplary embodiment of the present invention is a configuration regarding an optical channel monitor (hereinafter, referred to as an OCM) used in a wavelength division multiplexing transmission system. The configuration is illustrated in FIG. 6.

With reference to FIG. 6, an example of a WDM system is illustrated in which WDM signal light transmitted from an upper node through an optical fiber passes through an optical amplifier 410 to be branched by an optical branching device 420 and monitoring WDM light is input to an optical switching device 430. Main signal WDM light from the optical branching device 420 passes through another optical amplifier to be branched by another optical branching device and the monitoring WDM light is input to the optical switching device 430. The optical switching device sequentially inputs the monitoring WDM light to an OCM device 440. Although parameters such as a wavelength, an SN ratio, and the number of the WDM signal light from the upper node are optional, an NMS manages a modulation frequency for each wavelength.

The OCM device 440 is composed of a PD 441, an FFT 442, a variable filter 443, and a calculating unit 444.

When the calculating unit 444 calculates a peak of a frequency spectrum after FFT, it is possible to find a transmitted wavelength and to obtain signal light power of each wavelength.

Meanwhile, the calculator 444 not only calculates the peak of the frequency spectrum but also judge whether optical fiber connection is proper depending on whether the frequency obtained from the monitoring light from each optical branching device and the modulation frequency output from the NMS, which manages the modulation frequency for each wavelength, conform to each other. For example, as for the monitoring light from the optical branching device 420, when the frequency of the monitoring light and the modulation frequency from the NMS conform to each other, it may be judged that the optical fiber connection is proper. Next, as for the monitoring light from the optical branching device subsequent to the optical branching device 420, when the frequency of the monitoring light and the modulation frequency from the NMS do not conform to each other, it may be judged that the optical fiber connection is improper between the optical branching device 420 and the subsequent optical branching device.

Although a representative exemplary embodiment of the present invention is described above, the present invention may be implemented in various other modes without departing from the spirit and the primary feature thereof defined by claim of the present application. Therefore, the above-described exemplary embodiments are illustrative only and they should not be interpreted in a limited manner. The scope of the present invention is designated by claims and is not limited by the description in the specification and the abstract. Further, all modifications and changes belonging to equivalence of claims fall within the scope of the present invention.

The whole or part of the exemplary embodiments above can be described as the following supplementary notes, but are not limited thereto.

### Supplementary Note 1

An optical transmission system, comprising:

a transmitter including a light source and a dither modulator, the dither modulator applying dither modulation to light output from the light source;

an optical fiber which transmits signal light output from the transmitter;

an optical branching device which branches a part of the signal light transmitted by the optical fiber as monitoring light;

a frequency detector which detects a frequency of the monitoring light; and

a detector which detects whether the frequency of the monitoring light and a modulation frequency set in the dither modulator conform to each other.

### Supplementary Note 2

The optical transmission system according to the supplementary note 1, wherein the frequency detector comprises a photoelectric conversion element which converts the monitoring light to an electric signal, a Fourier transformer which applies Fourier transform to the electric signal, and a frequency variable filter which extracts a frequency of the signal to which the Fourier transform is applied.

### Supplementary Note 3

The optical transmission system according to the supplementary note 1 or 2, wherein the detector comprises a network management system (NMS), which sets the modulation frequency of the dither modulator, and an AND circuit to which an output of the frequency detector and the modulation frequency set by the network management system are input.

### Supplementary Note 4

The optical transmission system according to any one of the supplementary notes 1 to 3, comprising:

an aggregator connected to the transmitter through the optical fiber;

a selector connected to the aggregator through the optical fiber; and

a wavelength cross connect unit connected to the selector through the optical fiber,

wherein

at least one of the aggregator, the selector, and the wavelength cross connect unit comprises the optical branching device and the frequency detector.

### Supplementary Note 5

An optical transmission method, comprising:

transmitting signal light through an optical fiber, the signal light being obtained by applying dither modulation to light output from a light source by a dither modulator;

branching a part of the signal light transmitted by the optical fiber as monitoring light and detecting a frequency of the monitoring light; and

detecting whether the frequency of the monitoring light and a modulation frequency set in the dither modulator conform to each other.

### Supplementary Note 6

The optical transmission method according to the supplementary note 5, the optical transmission method being performed by an optical transmission system comprising a transmitter including the light source and the dither modulator, an aggregator connected to the transmitter through the optical fiber, a selector connected to the aggregator through the optical fiber, and a wavelength cross connect unit connected to the selector through the optical fiber, wherein

at least one of the aggregator, the selector, and the wavelength cross connect unit operates to branch a part of the signal light transmitted by the optical fiber as the monitoring light and detect the frequency of the monitoring light.

### Supplementary Note 7

An optical transmission system, comprising:

an optical branching device which branches a part of transmitted dither modulation signal light as monitoring light; and an optical channel monitor to which the monitoring light is input, wherein

the optical channel monitor includes a photoelectric conversion element which converts the monitoring light to an electric signal, a Fourier transformer which applies Fourier transform to the electric signal, a frequency variable filter which extracts a frequency of the signal to which the Fourier transform is applied, and a calculating unit which calculates a peak of a frequency spectrum output from the frequency variable filter.

### Supplementary Note 8

An optical transmission method, comprising:

branching a part of transmitted dither modulation signal light as monitoring light;

converting the monitoring light to an electric signal by a photoelectric conversion element;

applying Fourier transform to the electric signal;

extracting a frequency of the signal to which the Fourier transform is applied; and

obtaining a peak of a frequency spectrum.

1. An optical transmission system comprising:
a transmitter including a light source and a dither modulator, the dither modulator applying dither modulation to light output from the light source;
an optical fiber which transmits signal light output from the transmitter;
an optical branching device which branches a part of the signal light transmitted by the optical fiber as monitoring light;
a frequency detector which detects a frequency of the monitoring light; and
a detector which detects whether the frequency of the monitoring light and a modulation frequency set in the dither modulator conform to each other.

2. The optical transmission system according to claim 1, wherein the frequency detector comprises a photoelectric conversion element which converts the monitoring light to an electric signal, a Fourier transformer which applies Fourier transform to the electric signal, and a frequency variable filter which extracts a frequency of the signal to which the Fourier transform is applied.

3. The optical transmission system according to claim 1, wherein the detector comprises a network management system (NMS) which sets the modulation frequency of the dither modulator, and an AND circuit to which an output of the frequency detector and the modulation frequency set by the network management system are input.

4. The optical transmission system according to claim 1, further comprising:
an aggregator connected to the transmitter through the optical fiber;
a selector connected to the aggregator through the optical fiber; and
a wavelength cross connect unit connected to the selector through the optical fiber, wherein
at least one of the aggregator, the selector, and the wavelength cross connect unit comprises the optical branching device and the frequency detector.

5. The optical transmission system according to claim 2, further comprising:
an aggregator connected to the transmitter through the optical fiber;
a selector connected to the aggregator through the optical fiber; and
a wavelength cross connect unit connected to the selector through the optical fiber, wherein
at least one of the aggregator, the selector, and the wavelength cross connect unit comprises the optical branching device and the frequency detector.

6. An optical transmission system, comprising:
an optical branching device which branches a part of transmitted dither modulation signal light as monitoring light; and an optical channel monitor to which the monitoring light is input, wherein
the optical channel monitor includes a photoelectric conversion element which converts the monitoring light to an electric signal, a Fourier transformer which applies Fourier transform to the electric signal, a frequency variable filter which extracts a frequency of the signal to which the Fourier transform is applied, and a calculating unit which calculates a peak of a frequency spectrum output from the frequency variable filter.

7. An optical transmission method comprising:
transmitting signal light through an optical fiber, the signal light being obtained by applying dither modulation to light output from a light source by a dither modulator;
branching a part of the signal light transmitted by the optical fiber as monitoring light and detecting a frequency of the monitoring light; and
detecting whether the frequency of the monitoring light and a modulation frequency set in the dither modulator conform to each other.

8. The optical transmission method according to claim 7, the optical transmission method being performed by an optical transmission system comprising a transmitter including the light source and the dither modulator, an aggregator connected to the transmitter through the optical fiber, a selector connected to the aggregator through the optical fiber, and a wavelength cross connect unit connected to the selector through the optical fiber, wherein at least one of the aggregator, the selector, and the wavelength cross connect unit operates to branch a part of the signal light transmitted by the optical fiber as the monitoring light and detect the frequency of the monitoring light.
